(19) United States
(12) Patent Application Publication
(10) Pub. No.: US 2017/0070079 A1
(43) Pub. Date: Mar. 9, 2017

(54) A Wireless Charging Device and Methods of Use

(71) Applicant: Humavox Ltd., Kfar-Saba (IL)

(72) Inventor: Asaf Manova-Elssibony, Ramat Gan (IL)

(73) Assignee: Humavox Ltd., Kfar-Saba (IL)

(21) Appl. No.: 15/120,035

(22) PCT Filed: Feb. 22, 2015
(86) PCT No.: PCT/IL2015/050200

§ 371 Date: Aug. 18, 2016

Related U.S. Application Data
(60) Provisional application No. 61/943,341, filed on Feb. 22, 2014.

(51) Int. Cl. H02J 7/02; H02J 50/20; H02J 7/04

(52) U.S. Cl. CPC H02J 7/025; H02J 7/042; H02J 50/20

(57) ABSTRACT

The invention is directed to a wireless charging device having a Pulse Width Modulation (PWM) unit integrated within a transmitting unit of said wireless charging device and configured to modulate RF energy transmission to a device under charge according to real time analysis of the charging process, said PWM unit is connected to a charging tracking module and to controller, wherein said charging tracking module is adapted to provide data reflecting the progress of said charging process and said controller is adapted to receive said data from said charging tracking module and adjust the duty cycle of said PWM unit according to the data obtained, so as to adjust the transmitted power to the wireless charging process and thus, to have minimal energy loss during said wireless charging process. The invention is further directed to a wireless charging system comprising a wireless charging device according to the above and a device under charge, wherein during the wireless charging process the transmission of RF energy by the transmitting unit is enabled according to the duty cycle of the PWM that changes according to the progress of the charging process, so as to provide a desired average power level to a receiving unit in the device under charge while keeping a peak power level transmitted for maintaining a high power conversion efficiency.

### FIELD OF THE INVENTION

The present invention is related to wireless charging device in general, and to a wireless charging device having a Pulse Width Modulation for modulating transmitted RF power according to the progress of a charging process in a device to be charged in particular.

### BACKGROUND OF THE INVENTION

Charging batteries is a process with a unique profile that varies from one type of battery to another and thus, sometimes it requires a high capacity and sometimes it requires a lower capacity. In addition, during the charging process itself the capacity may vary according to the power requirements of the battery cell and the charging level of the charged battery. When charging is performed via harvesting processes there is a difficulty to obtain low capacity without decrementing the conversion efficiency from RF to DC voltage. Generally, in order to obtain a high conversion efficiency there is a need to coordinate between the harvesting circuits to the expected RF power level. This is usually obtained by an impedance matching unit that brings a diode comprised within the harvesting circuit into operation point upon reaching a predefined power value. However, when a lower capacity is required, there is a need to maintain the diode in the harvesting circuit in an operation mode without reducing the conversion efficiency.

Current solutions usually use a current regulator that is generally a large unit that requires a large volume. When small devices are involved, the volume of each component is crucial. Additionally, while using a current regulator as a solution, a part of the converted current that is not required in the specific process is lost (usually transferred into heat), thus, there is a vast energy waste.

The present invention provides an efficient solution that minimizes or even prevents extensive energy loss that usually occurs in a wireless charging process, and further allows decreasing the size of the device under charge by minimizing the components volume inside it as will be described hereunder.

### SUMMARY OF THE INVENTION

The subject matter disclosed herein is directed to a wireless charging device having a Pulse Width Modulation (PWM) unit integrated within a transmitting unit of said wireless charging device and configured to modulate RF energy transmission to a device under charge according to real time analysis of the charging process progress, said PWM unit is connected to a charging tracking module and a controller, wherein said charging tracking module is adapted to provide data reflecting the progress of said charging process and said controller is adapted to receive said data from said charging tracking module and adjust the duty cycle of said PWM unit according to the data obtained, so as to adjust the transmitted power to the wireless charging process. By adjusting the RF transmitted power to the charging process progress, the loss of energy during the wireless charging process is minimal. In accordance with embodiments of the invention, the wireless charging process is being regulated according to data received by the charging tracking module, said data indicates one of the following: (a) real time changes in RF energy level within a charging zone created within said wireless charging device; (b) the ratio between the transmitted RF energy and the reflected RF energy, said data is further analyzed by said controller so as to determine a desired duty cycle of the PWM unit, which is required for obtaining a desired transmitted RF power for the charging process. The data may be obtained by any communication technique known in the art for data transferring.

The term “charging zone” as used herein refers to a volume/space within the wireless charging device in which a charging process is to occur and in which a device to be charged is to be located. The charging device is described in details in our PCT application, published as WO 2013/179284 and in our PCT application PCT/IL2014/050729, the content of which are incorporated herein by reference. The PWM unit functionally operates to enable a transmitter of said transmitting unit for obtaining a desired average transmitted power for charging. It should be emphasized that the proposed usage of a PWM unit to modulate a transmitted RF power for wireless charging is novel by itself as the prior art system make use of the PWM unit for data transmission purposes.

During the wireless charging process the duty cycle of the PWM is changed, so as to maintain a fixed peak power level transmitted by the transmitting unit so as to keep a high conversion efficiency of the transmitted RF energy, while changes in the power requirements of the rectifying unit are satisfied by changing the average power level transmitted (the average is changed by changing the duty cycle of the PWM unit that functionally enables the transmitter) as will be explained in details below and better understood from the accompanying drawings.

In accordance with variations of the invention, the charging tracking module is either one of a sensor or a reflection coefficient monitor (S11). In some other embodiments of the invention the charging tracking module may be another communication technique allowing to data transfer indicative of the charging process. In the first variation, the tracking module is preferably a sensor that samples the changes in the RF energy level, while in the second variation the tracking module is S11 monitor that measures the ratio between the transmitted RF energy and the reflected RF energy, this ratio indicates the transmission coefficient i.e. this monitor provides data as to the entire return loss of the transmitting unit when transmitting a signal or power. The controller analyses this data and adjust the transmission of RF energy according to the best value obtained that indicates optimal charging based on the ratio between the transmitted RF energy and the reflected RF energy.

The subject matter described herein is also directed to a wireless charging system comprising a wireless charging device having a PWM unit as described in the above, and a device under charge, wherein during a wireless charging process the transmission of RF energy by the transmitting unit is enabled according to the duty cycle of the PWM unit, which changes according to the progress of the charging process, so as to provide a desired power level to a receiving unit in the device under charge. Thus, an average DC power level received from a rectifier in the device under charge is functionally being determined according to the duty cycle of the PWM in the transmitting unit of the wireless charging device, said duty cycle is modulated by the controller according to real time readings of the charging process progress and correspondent signals obtained by the charging tracking module. In summary, the charging tracking module may provide data indicating one of the following: (a) real time changes in RF energy level within the charging zone created within the wireless charging device; (b) the ratio between the transmitted RF energy and the reflected RF energy (S11), wherein said data is further analyzed by the controller so as to determine the duty cycle of the PWM unit which is required for obtaining a desired transmitted RF power level for charging the device under charge.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A is a schematic illustration of a charging system with a transmitting unit, and a receiving unit comprising a current regulator element, illustrating the common state of art.

FIG. 1B is a close up view of the current regulator element of FIG. 1A.

FIG. 1C is a graphic illustration of the transmitter output of the transmitting unit illustrated in FIG. 1A.

FIG. 1D is a graphic illustration of the transmitted power of the transmitting unit illustrated in FIG. 1A.

FIG. 1E is a graphic illustration of the received power by the receiving unit illustrated in FIG. 1A.

FIG. 1F is a graphic illustration of the rectified DC power received from the receiving unit illustrated in FIG. 1A.

FIG. 1G is a graphic illustration of the rectified DC current received from the receiving unit illustrated in FIG. 1A.

FIG. 1H is a graphic illustration of a PWM signal enabling the switching unit in the current regulator illustrated in FIG. 1A.

FIG. 1I is a graphic illustration of the regulated current received from the current regulator in the receiving unit illustrated in FIG. 1A.

FIG. 2A is a schematic illustration of a novel charging system with a transmitting unit comprising a PWM unit connected to controller that receives signals as to the charging process progress of a device to be charged from a sensor, and a receiving unit in accordance with variations of the present invention.

FIG. 2B is a schematic illustration of a novel charging system with a transmitting unit comprising a PWM unit as illustrated in FIG. 2A, wherein the controller obtains indications as to the charging process of a device under charge from a S11 monitor, and a receiving unit in accordance with variations of the present invention.

FIG. 2C is a graphic illustration of the transmitter output of the transmitting unit illustrated in FIGS. 2A and 2B.

FIG. 2D is a graphic illustration of the PWM signal that functionally operates as a switch that enables the transmitter illustrated in FIGS. 2A and 2B.

FIG. 2E is a graphic illustration of the transmitted power of the transmitting unit illustrated in FIGS. 2A and 2B.

FIG. 2F is a graphic illustration of the received power by the receiving unit illustrated in FIGS. 2A and 2B.

FIG. 2G is a graphic illustration of the rectified DC power received from the rectifier of the receiving unit illustrated in FIGS. 2A and 2B.

FIG. 2H is a graphic illustration of the rectified DC current received from the rectifier of the receiving unit illustrated in FIGS. 2A and 2B.

### DETAILED DESCRIPTION OF EMBODIMENTS

In the following description, various aspects of a novel wireless charging devise and system for increasing energy transfer efficiency in a wireless charging process of a device under charge is described. For the purpose of explanation, specific configurations and details are set forth in order to provide a thorough understanding of the system.

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Furthermore, it should be understood that the disclosure can be carried out or practiced in various ways, and that the disclosure can be implemented in embodiments other than the exemplary ones described herein below. The descriptions, examples and materials presented in the description, as well as in the claims, should not be construed as limiting, but rather as illustrative.

Reference is now made to the figures.

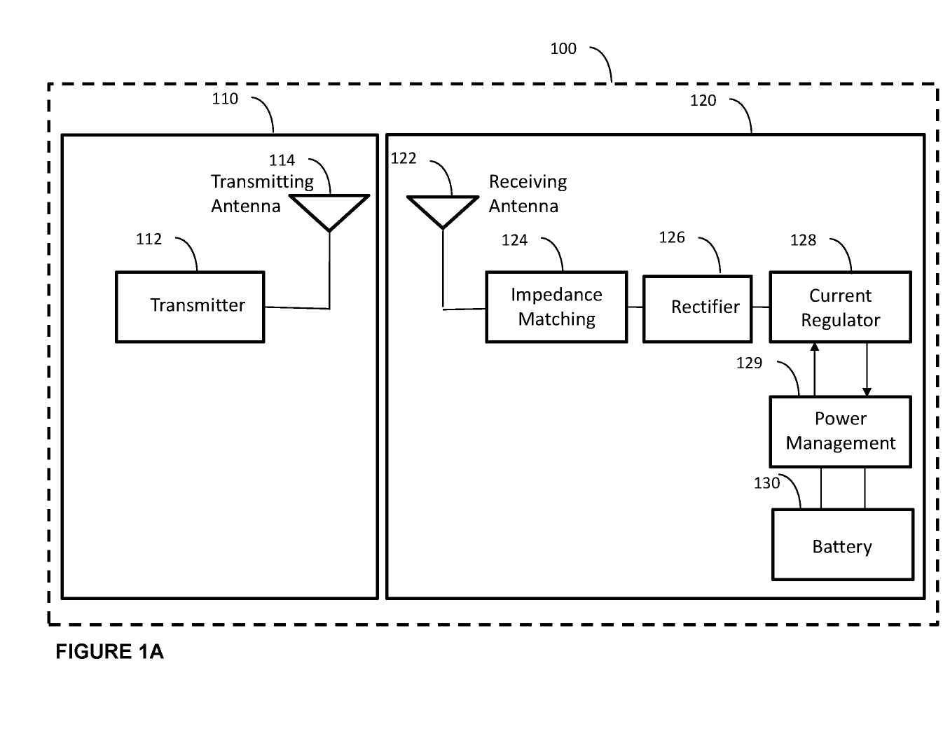

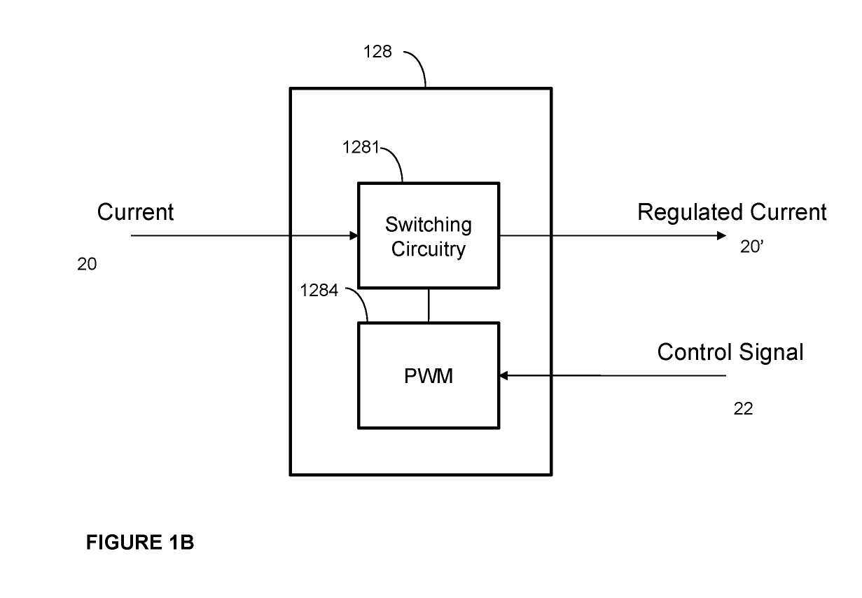

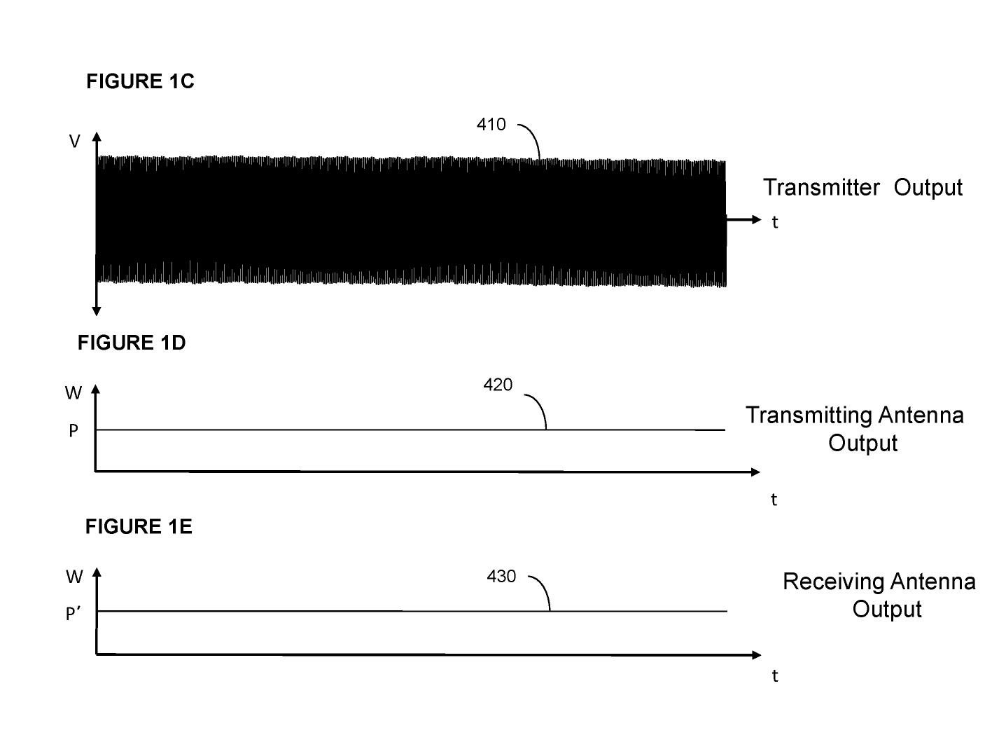

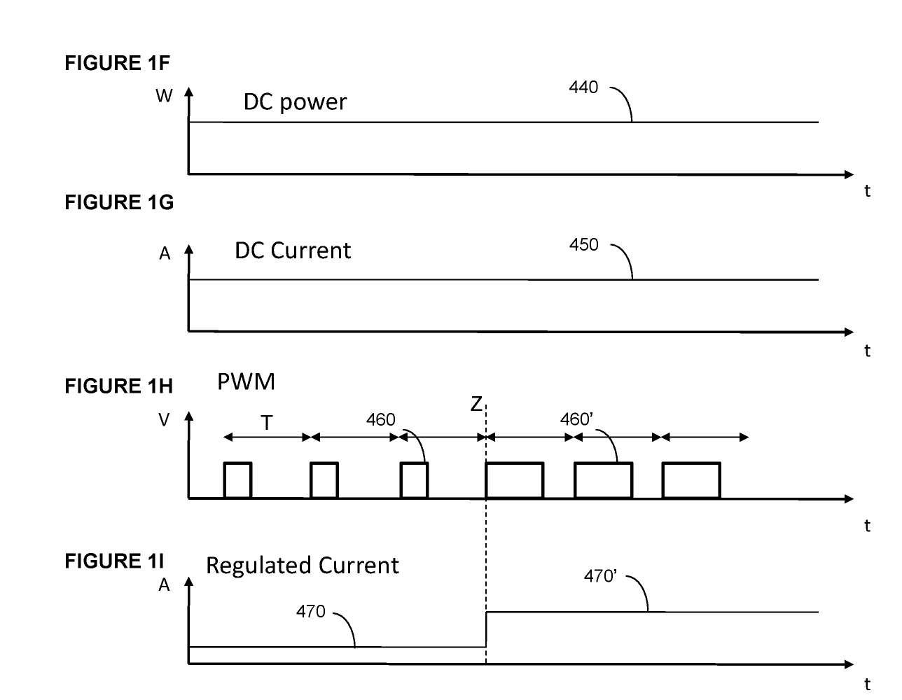

FIG. 1A is a schematic illustration of a wireless charging system 100 with a current regulator unit 128 illustrating the common state of art. The system comprises a transmitting unit 110, a receiving and harvesting unit 120 that is functionally connected to a battery 130 to be charged. Alternatively, the harvesting unit 120 may be connected to a load (not shown). Transmitting unit 110 contains at least a transmitter 112 and a transmitting antenna 114.

Receiving and harvesting unit 120 comprises a receiving antenna 122, an impedance matching unit 124, a rectifier 126, a current regulator 128, and a power management unit 129 that is configured and operable to be connected to a rechargeable battery 130 or to a storage unit of a rechargeable device (not shown).

Transmitter 112 transmits constant power to transmitting antenna 114 that transmits RF power to the wireless charging device cavity (cavity is not shown) or to a predefined space. The transmitted radiation is received by receiving antenna 122 of receiving and harvesting unit 120. The received RF power is converted into DC (direct current) by rectifier 126. The converted current flows into a current regulator unit 128 that is configured to adjust the current level according to the battery cell charging requirement. A close up view of the current regulator unit 128 is described with reference to FIG. 1B below. Power management unit 129 is configured and operable to manage the charging process of battery 130, by controlling the current regulator unit 128 in order to deliver the required charging current to battery 130 according to the charging requirement of the battery. Receiving and harvesting unit 120 in the configuration illustrated in this figure is suitable to systems with a constant consumption as the impedance matching unit 124 is correlated to a constant predefined receiving power.

FIG. 1B illustrates the current regulator unit 128 of FIG. 1A. Current regulator 128 comprises a switching circuitry 1282 and a Pulse-Width Modulation (PWM) unit 1284. The usage of a PWM unit allows modulation technique that conform the width of a pulse, i.e., adjust the pulse duty cycle, based on control signal information. This modulation technique can be used to encode information for transmission, and also can be used to allow the control of the power supplied to electrical devices, especially to inertial loads such as motors. The average value of voltage (and current) feed into the load is controlled by turning the switch between supply and load on and off at a fast pace. The longer the switch is on compared to the off periods, the higher the power supplied to the load. The PWM switching frequency should be much faster than what would affect the load, which is to say than the device that consumes the power. The proportion of ‘on’ time to the regular interval or ‘period’ of time is described by the term duty cycle. A low duty cycle corresponds to low power, because the power is off for most of the time. Duty cycle is expressed in percent, 100% being fully on. The advantage of the PWM technique is that power loss in the switching devices is very low. When a switch is off there is practically no current, and when it is on, there is almost no voltage drop across the switch. Power loss, being the product of voltage and current, is thus in both cases close to zero.

Also shown in this figure are input current 20 that output the switching circuitry 1282 as regulated current 20′, control signal 22 that enters PWM unit 1284. Control signal 22 received from power management unit 129 (shown in FIG. 1A) is configured to determine the required duty cycle of the PWM unit 1284 which produce the correct charging current according to the battery 130 charging state.

FIGS. 1C to 1E are graphic illustrations of the output of the transmitting and receiving components of system 100 illustrated in FIG. 1A along time duration (t), wherein transmitter 112 output value 410 (V) along time duration (t) (FIG. 1C) showing the original signal power transmitted from the transmitter 112; the transmitted power Tx value 420 (W) that output from the transmitting antenna 114 along time duration (t) (FIG. 1D); and the received power 430 (W) received by receiving antenna 122 (FIG. 1E), all illustrated in FIG. 1A.

The value 410 describes the amplitude (v) of the signal generated by the transmitter over time (t). The transmitted power of the transmitting antenna 114 and the power received from the receiving antenna 122 are measured as the power level (w) over time (t). The values of both are constant over time as the original signal received from the transmitter in this configuration, is also constant. The received power level P′ is proportional to the transmitted power level P only smaller due to the fact that part of the RF transmitted power is lost.

FIGS. 1F and 1G are graphic illustrations of the rectified DC power 440 received from the rectifier measured as the DC power level (w) over time (t), and the rectified DC current 450 received from the rectifier measured as DC current level (A) over time (t) respectively. As shown in the figures, the power and the current levels have constant values 440 and 450 respectively that are correlative to the received power level illustrated in FIG. 1E.

FIG. 1H illustrates the PWM signal that enables the switching unit within the current regulator. Control signal 22 (illustrated in FIG. 1B) outputs from the power management unit 129 and enters the PWM unit 1284. The PWM signal 460 and 460′ expressed as voltage (v) over time (t) activates the switching unit of the current regulator according to its duty cycle during period T that changes at time point Z.

FIG. 1I schematically illustrates the regulated current (A) levels 470 and 470′ received from the current regulator over time (t) before and after time point Z respectively to the duty cycle of the PWM signal 460 and 460′. This figure further demonstrates the energy lost occurring during this process as the value of the regulated current drastically decreases due to the switching unit and the PWM operation. The power loss is the delta between 1G to 1I.

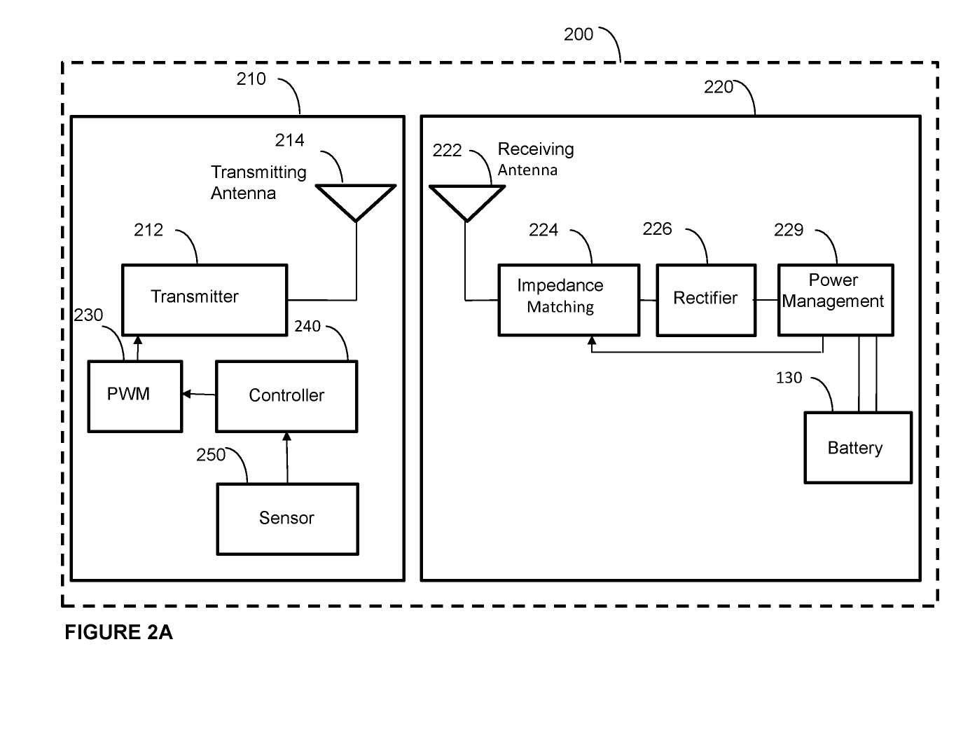

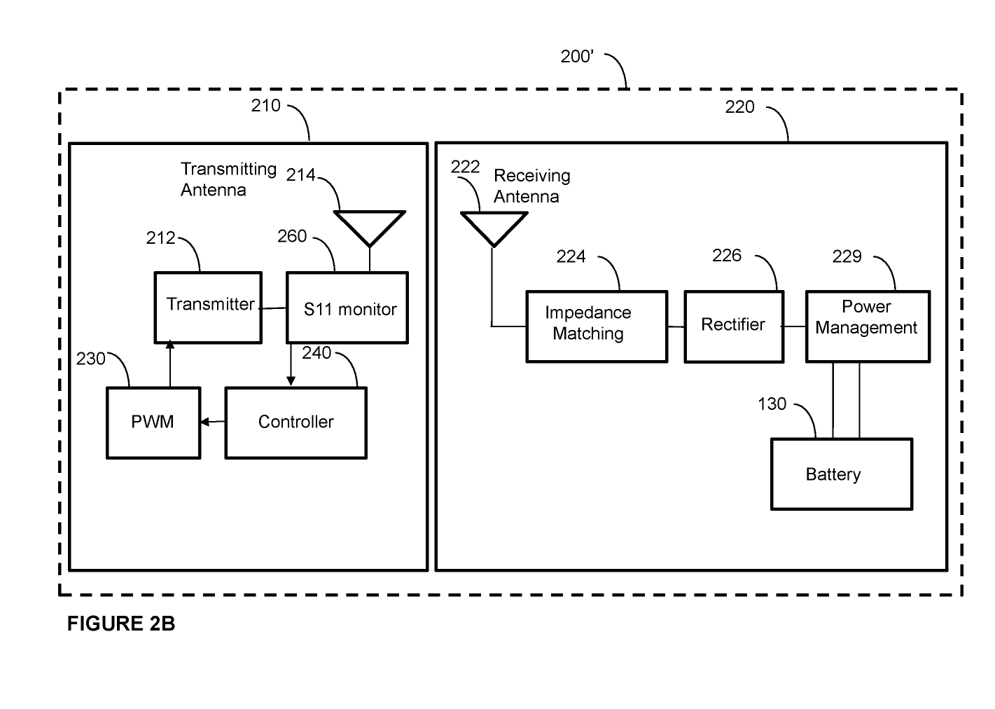

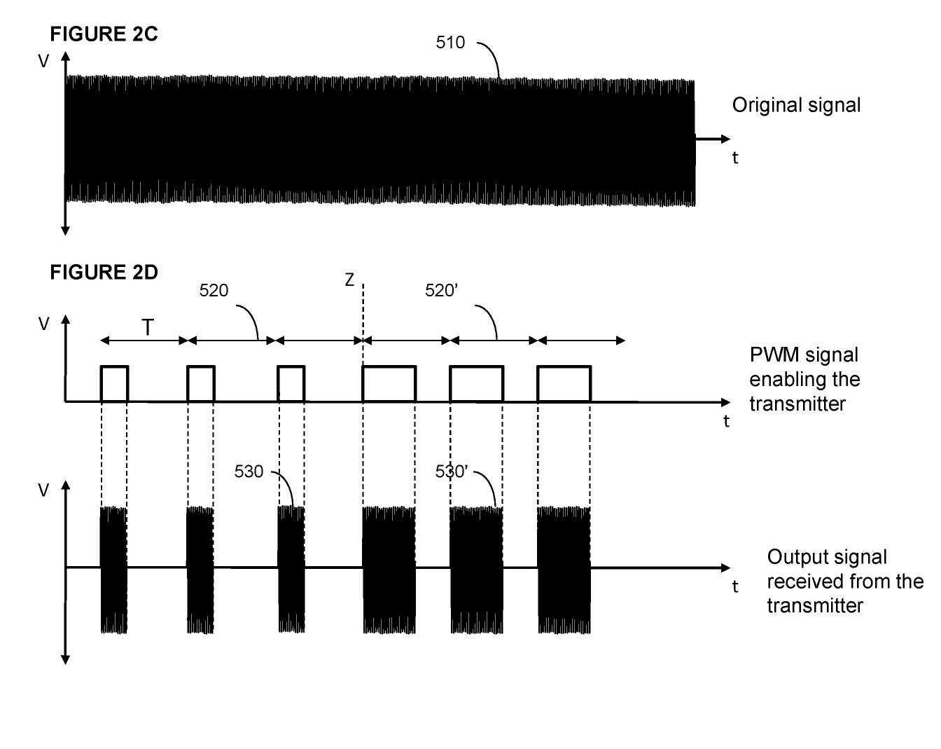

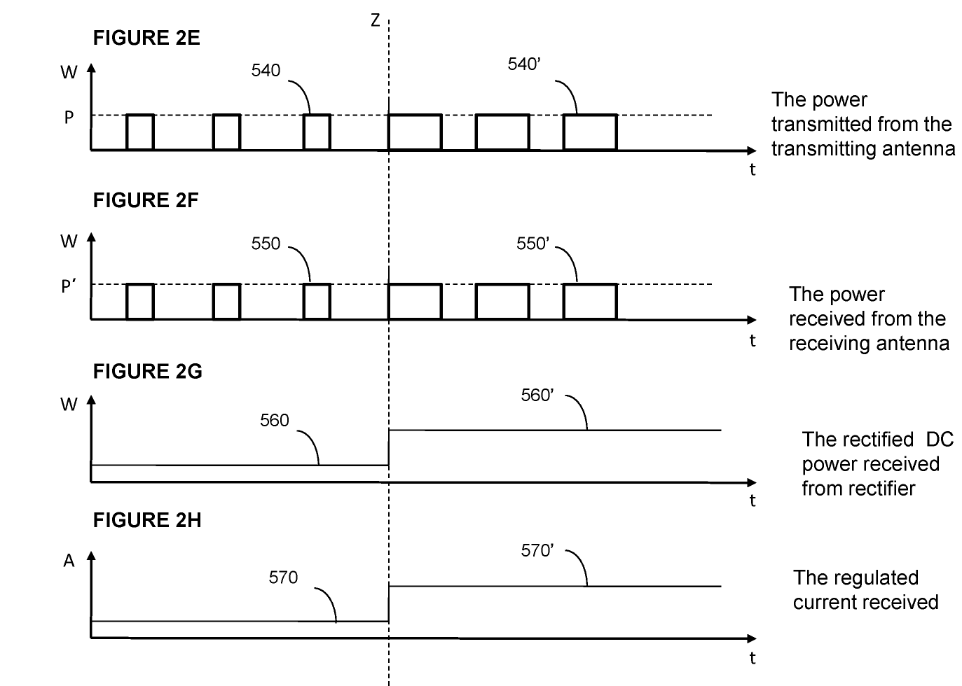

FIGS. 2A and 2B are a schematic illustrations of a wireless charging system 200 and 200′ comprising a transmitting unit 210 having a PWM unit 230 configured and operable to allow prevention of energy loss, and a receiving and harvesting unit 220 that is functionally connected to a battery 130 to be charged. Alternatively, the harvesting unit 220 may be connected to a load (not shown), wherein system 200 comprises a charging tracking module implemented as a sensor 250 (FIG. 2A), while system 200′ comprises a charging tracking module implemented as S11 monitor 260.

In a preferred embodiment of the invention the transmitting unit 210 is implemented in a wireless charging device. However, it should be clear that transmitting unit 210 in accordance with examples of the present invention may also be a standalone unit. Transmitting unit 210 contains at least a transmitter 212 connected to a transmitting antenna 214 from one end, and to a PWM unit 230 on the other end. The PWM unit is functionally connected to a controller 240 configured to control the operation of the PWM unit 230 according to the input it receives from a charging tracking module that in this implementation is a sensor 250. Compared to the prior art system the PWM unit is relocated at the transmitting unit, thus, enables to minimize the size of the receiving unit and to allow implementation of the receiving unit within various devices to be charges, in which, size and volume are crucial factors. Furthermore, the positioning of the PWM unit 230 within the transmitting unit 210 and the fact that the PWM unit enables the operation of transmitter 212 allows to control the output signal received from the transmitter according to the inputs obtained by from sensor 250, and analyzed by controller 240 to thereby avoid waste of energy by constant transmission pattern as in the prior art state. In accordance with the present invention transmitting antenna 214 transmits only when the PWM unit allows the transmitter 212 to operate in accordance with inputs about the charging process of the battery 130 and the required power level. Thus, the invention allows energy saving by adapting the transmitter operation to the power required by the charged device (battery and/or load).

In some embodiments of the invention the charging tracking module may be a sensor. An example of such sensor is provided in our PCT application no. WO 2013/179284 mentioned above. In such case, the sensor is usable for providing indications associated with the charging process that is being carried out. More particularly, the sensor is used for indicating the efficiency of the charging process, wherein the sensor may further be used to communicate between the device under charged and the control unit of the charging device. In some embodiments, the sensor is configured for measuring radiation intensity in the vicinity of the sensor, thereby enabling controlling intensity distribution of the radiation within the charging zone. The sensor may comprise at least one sensing antenna located at a known distance from the charging zone, to thereby enable controlling the intensity distribution of the radiation within the charging zone.

In some other embodiments of the invention, charging tracking module is a reflection coefficient S11 monitor 260 as described in details in our PCT/IL2014/050729 of the same inventor mentioned above. In this variation, the S11 monitor 260 is connected to the transmitter 212 and to transmitting antenna 214 and provides data as of the ratio between the transmitted powers to the reflected powers (S11 value). This value is delivered to controller 240 that according to the read values modulates the PWM unit 230.

In both scenarios, the charging tracking modules allows tracing the operation point of the rectifier in the receiving unit of the device under charge and accordingly the controller modulate the transmitter of the transmitting unit in the wireless charging device. In this manner, the system as a whole allows “smart” transmission of RF power and saving of energy, wherein thanks to the modulation of the PWM unit, a high conversion efficiency of the transmitted RF energy to DC is maintained as the system allows to follow the operation point of the rectifier and optimize the conditions of charging by changing the duty cycles of the PWM unit that enables to obtain a desired average power levels as described in details with reference to the figures.

Also shown in these figures are receiving and harvesting unit 220 that comprises a receiving antenna 222, an impedance matching unit 224, a rectifier 226, and a power management unit 229 that is configured and operable to be connected to either one of: a rechargeable battery 130, a load or a storage unit of a rechargeable device (not shown). The use of a PWM unit in such configuration obviate the need for using an adaptive impedance matching unit although the receiving unit requires during the process less DC power for charging and/or operating. The system provided herein is configured to provide less power in the same conversion efficiency with no need for adaptive impedance matching as the average DC power received from the rectifier is determined according to the duty cycle of the PWM in the transmitting unit. Thus, this implementation allows saving both, money and space within the device under charge.

FIGS. 2C to 2H are graphic illustrations of the original signal transmitted 510 from the transmitter (FIG. 2C), the functional transmitted signals 530 and 530′ enabled by the PWM unit according to duty cycle 520 and duty cycle 520′ after time point Z (FIG. 2D), the respective power transmitted from the transmitting antenna 540 and 540′ (before and after time point Z when the duty cycle of the PWM changes) (FIG. 2E), the respective power received from the receiving antenna 550 and 550′ before and after the duty cycle changes (FIG. 2F), the rectified DC power received from the rectifier before the duty cycle of the PWM changes 560 and after the change 560′ (FIG. 2G), and the regulated current received before time point Z 570 and after time point Z 570′ (FIG. 2H). Time point Z designate a time point in which the duty cycle of the PWM unit changes in a response to a change that occurs in the charging system, for example but not limited to, a change in the rectifier power demand that may occur due to a change that occurs in the operation point of the rectifier, a change in the current consumption of the PWM unit, or else. In more details, FIG. 2C graphically illustrates the original signal 510 with voltage amplitude (v) received from the transmitting unit illustrated in FIGS. 2A-2B over time (t). The original signal is enabled according to the duty cycle of the PWM unit as illustrated with reference to FIG. 2D. PWM signal 520 functionally operates as a switch that enables the transmitter output signal 530 over time (t). The duty cycle of the PWM 520 changes at time point Z, such that the duration of the “On” state increases relative to the “Off” state at the new duty cycle 520′ i.e. a relative increase in the output signal received from the transmitter 530′ is obtained. FIGS. 2E-2F are graphic illustrations of the transmitted power 540 and 540′ transmitted from the transmitting antenna and the received power 550 and 550′ before and after the change in the duty cycle of the PWM unit (Z time point), received from the receiving antenna respectively. As shown in the figures, the power transmitted and the power received are segmented and correlative to the PWM signal that enables the transmitter.

At the beginning of the charging process, the controller 240 may conduct a swift through various combinations of duty cycles of the PWM unit until a good indication that charging process occurs is obtained either by signals read from sensor 250 or when the best S11 value is obtained from S11 monitor 260, both indicating that an optimal duty cycle is achieved in which, the rectifier has reached its optimal operation point. The controller maintain this duty cycle as long as the operation point of the rectifier remains the same. Upon detection of a change in the power requirements of the device under charge, the operation point of the rectifier changes and the controller changes the duty cycle of the PWM that enables the transmitter until a new optimal operation point of the rectifier is achieved. The usage of PWM unit for that purpose allows maintaining high conversion efficiency without including active components for power level adjustment at the receiving side for that purpose and as a result, allows saving space in the device under charge and further to lower costs.

In addition to the above, the usage of a PWM for enabling the transmitter functionally allows maintaining a fixed output power level and remaining within the optimal operation range of the rectifier, as the peak value remains the same during the changes in the duty cycle, and on the same time, it allows changing the DC level as the average power level decrease/increase according to the power requirements of the rectifying unit of the device under charge in real time.

Also, the segmented power illustrated in these figures express the energy saving that the novel system provides compared to prior art that is based on a constant transmission of energy, as the segments are reflecting the states of the transmitter (enabled v. not enabled). It should be emphasized that since the transmitted power level is fixed a high conversion power is maintained and the adjustment to the system requirements as to the charging current and total power is amended according to the average power that is correlative to the specific duty cycle set by the controller at a specific time point.

FIGS. 2G-2H are graphic illustrations of the rectified DC powers 560 and 560′ received from the rectifier before and after the change in the duty cycle of the PWM unit respectively along period T, and the regulated DC current 570 and 570′ received from the rectifier of the receiving unit illustrated in FIG. 2A with respect to the transmitted signals according to FIGS. 2C to 2D before and after the change in the duty cycle of the PWM. Both graphs demonstrate respective change of the average power level and charging current that follows the changes that occur in the duty cycle of the PWM and the transmitter enablement. These graphs also demonstrate the economy of energy that the novel system allows compared to prior art, as the power transmitted is adjusted to the real time requirements of the charged device.

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

1. A wireless charging device having a Pulse Width Modulation (PWM) unit integrated within a transmitting unit of said wireless charging device and configured to modulate RF energy transmission to a device under charge according to real time analysis of the charging process progress, said PWM unit is connected to a charging tracking module and to controller, wherein said charging tracking module is adapted to provide data reflecting the progress of said charging process and said controller is adapted to receive said data from said charging tracking module and adjust the duty cycle of said PWM unit according to the data obtained, so as to adjust the transmitted power to the wireless charging process.

2. A wireless charging device according to claim 1, wherein said wireless charging process is being regulated according to data received by said charging tracking module, said data indicates one of the following: (a) real time changes in RF energy level within a charging zone created within said wireless charging device; (b) the ratio between the transmitted RF energy and the reflected RF energy, said data is further analyzed by said controller so as to determine a desired duty cycle of the PWM required to allow desired transmitted RF power for charging.

3. A wireless charging device according to claim 1, wherein said PWM unit functionally operates to enable a transmitter of said transmitting unit for obtaining a desired average transmitted power for charging.

4. A wireless charging device according to claim 1, wherein during said wireless charging process the duty cycle of the PWM unit is changed, so as to maintain a fixed peak power level transmitted by said transmitting unit.

5. A wireless charging device according to claim 1, wherein said charging tracking module is either one of a sensor or a reflection coefficient monitor (S11).

6. A wireless charging system comprising a wireless charging device having a PWM unit according to claim 1, and a device under charge, wherein during said wireless charging process the transmission of RF energy by said transmitting unit is enabled according to the duty of cycle of the PWM that changes according to the progress of the charging process, so as to provide a desired power level to a receiving unit in the device under charge.

7. A wireless charging system according to claim 6, wherein an average DC power level being received from a rectifier in said device under charge is determined according to the duty cycle of said PWM unit in said transmitting unit of the wireless charging device, said duty cycle is modulated by said controller according to real time reading of the charging process progress by said charging tracking module.

8. A wireless charging system according to claim 7, wherein said charging tracking module provides data indicating one of the following: (a) real time changes in RF energy level within a charging zone created within said wireless charging device; (b) the ratio between the transmitted RF energy and the reflected RF energy (S11), wherein said data is further analyzed by the controller so as to determine a duty cycle of the PWM unit, which is required to allow a desired transmitted RF power level for charging.

9. A wireless charging system according to claim 7, wherein during the charging process the duty cycle of the PWM is changed, so as to keep a fixed peak power level transmitted by the transmitting unit for maintaining a high conversion efficiency of the transmitted RF energy, while changes in the power requirements of the rectifying unit are satisfied by changing the average power level transmitted, by changing the duty cycle of the PWM unit that enables the transmitter, wherein an average DC power level received from a rectifier in the device under charge is functionally being determined according to the duty cycle of the PWM in the transmitting unit.

10. A wireless charging device according to claim 1, wherein during the charging process the duty cycle of the PWM is changed, so as to maintain a fixed peak power level transmitted by the transmitting unit for maintaining a high conversion efficiency of the transmitted RF energy.
